(19) United States
(12) Patent Application Publication
(10) Pub. No.: US 2005/0063539 A1
(43) Pub. Date: Mar. 24, 2005

(54) Prime-number-based method and apparatus for generating random numbers

(76) Inventors: Jerry Joe Langin-Hooper, Colorado Springs, CO (US); Kanan Joseph Langin-Hooper, Colorado Springs, CO (US)

Correspondence Address: LINDA FLEWELLEN GOULD, 1665 BRIARGATE BLVD. #101, COLORADO SPRINGS, CO, 80920, US

(21) Appl. No.: 10/666,596

(22) Filed: Sep. 18, 2003

(51) Int. Cl. H04L 9/00

(52) U.S. Cl. 380/44

(57) ABSTRACT

Random numbers are used for a variety of purposes and play key roles in systems such as simulation studies, information processing, communication, and encryption. Truly random numbers are generally the result of processes that cannot be successfully repeated to generate the same sequence of results, and thus are unpredictable. Pseudo-random numbers, on the other hand, are easily replicated as the output of deterministic processes. Such a series of pseudo-random numbers will eventually repeat itself in perpetuity once it has exhausted its cycle length. The claimed invention introduces a new class of random numbers called idem-random numbers that have many of the essential characteristics of random numbers but which may be successfully replicated at different locations and at different times and which will never repeat themselves. The claimed invention uses the characteristics of prime and prime-like numbers to create endless sequences of idem-random numbers. Idem-random numbers are produced by a.) identifying a seed prime or prime-like number, b.) identifying a process or condition for determining a subsequent prime or prime-like number, c.) applying that process or condition in an iterative fashion to yield a sequence of prime or prime-like numbers, d.) identifying a mathematical relationship or property which can be applied to two or more numbers in that prime or prime-like number sequence, and e.) applying that mathematical relationship or property to the sequence of numbers to provide a set of idem-random numbers. Optional application of a distribution-transformation process may beneficially create final idem-random numbers with specified distribution characteristics.

### BACKGROUND OF THE INVENTION

1. Field of the Invention

The present invention relates generally to a method of and apparatus for generating random numbers. 2. Description of the Prior Art Random numbers are used for a variety of purposes and play key roles in systems such as simulation studies, information processing, communication, and encryption. Random numbers are often used as the initial inputs or seeds for processes that create other, longer sequences of pseudo-random numbers. Truly random numbers typically are the result of physical processes that cannot be successfully repeated to generate the same sequence of results. For example, the decay of nuclear isotopes, the static created by lightning discharges, or the spurious electrical charges induced by shifts in the earth's magnetosphere could all be used to drive the creation of random numbers that cannot be replicated at another location or at another time.

Several mathematically based processes have been developed that create pseudo-random numbers that exhibit excellent randomness characteristics. The discrete logarithm process of Blum and Micali; the quadratic residuosity process of Blum, Blum and Shub; the one-way functions of Yao; the RSA factoring process of Alexi, Chor, Goldreich and Schnorr; and the tree structure of Micali and Schnorr are all used to create pseudo-random number sequences that can be readily replicated. These processes can be appropriately labeled pseudo-random number processes since they create results that resemble random numbers, but are not technically random. These processes transform short random seeds into longer pseudo-random number sequences with random number-like characteristics. All of the subsequent pseudo-random numbers are derived strictly from the initial random seeds and from the properties of the processes. Rapid processing speed is a key advantage of these techniques and the complexity of the calculations in the processes makes the resulting pseudo-random numbers sequences extremely difficult to predict. However, no new “randomness” is introduced into the processes once the initial random seeds have been provided.

### SUMMARY AND OBJECTS OF THE INVENTION

One object of the invention is to provide a technique for the creation of an unlimited quantity of numerical values which are indistinguishable from those values generated by truly random processes.

Accordingly, it is another object of this invention to provide a method and apparatus for the creation of an unlimited quantity of numerical values having specific distributional characteristics that are indistinguishable from those values generated by truly random processes having those same specific distributional characteristics.

Another object of this invention is to provide a fully deterministic technique that can be replicated at distinct locations and at different times for the creation of an unlimited quantity of numerical values which are indistinguishable from those values generated by truly random processes.

Another object of this invention is to provide a fully deterministic technique that can be replicated at distinct locations and at different times for the creation of an unlimited quantity of numerical values having specific distributional characteristics that are indistinguishable from those values generated by truly random processes having those same specific distributional characteristics.

Another object of this invention is to introduce a new class of random numbers called idem-random numbers that are essentially identical to truly random numbers, having the fundamental characteristics of random numbers, but which may be successfully replicated at different locations and at different times.

Briefly, the claimed invention introduces a set of processes and methods for generating a new class of random numbers called idem-random numbers. These idem-random numbers are essentially identical to random numbers because they have the fundamental characteristics of random numbers. Anticipation or prediction of the next sequential idem-random value is effectively impossible, as is true of random numbers. However, sequences of idem-random numbers may be successfully replicated at different locations and at different times. Because the results can be reproduced, they are not truly random, but additional “randomness” is continually introduced into the generation process through the very nature of the numerical systems that underlie the creation of the idem-random numbers. Further, idem-random numbers do not exhibit the cyclical repetition found in pseudo-random numbers. Thus, the idem-random number generation processes and apparati of the claimed invention offer significant advantages over those that generate pseudo-random numbers.

The claimed invention uses the numerical properties of prime and prime-like numbers to create sequences of idem-random numbers. To date and even after thousands of years of research, no procedure has been found to quickly identify prime numbers, particularly very large prime numbers. More importantly, given a very large prime number, no procedure is known that will successfully predict or identify the next and other successive prime numbers without expending considerable computational effort. Prime-like numbers, as described herein, share almost all of the relevant characteristics of prime numbers. In essence, the mathematical relationships (such as distance or difference) between a large prime or prime-like number and successive prime (or prime-like) numbers or the properties of such large prime or prime-like numbers are non-predictable, essentially random values. Such mathematical relationships or properties are used in the claimed invention to create idem-random numbers. The idem-random numbers so generated are indistinguishable from random numbers generated by truly random processes. In addition, the supply of such idem-random number is limitless, facilitating the development of systems that require very large quantities of effectively-random numbers.

A prime number is a positive integer that is evenly divisible by only two numbers—one and itself. For the purposes of this claimed invention, prime-like numbers share characteristics with prime numbers that make mathematical relationships between such prime-like numbers or properties that such prime-like numbers possess the same non-predictable, essentially random characteristics as the relationships and properties of prime numbers. Prime-like numbers include multi-primes, super-primes, probable-primes, and other combinations of selection sets yielding numbers that share the essential characteristics of prime numbers.

For the purpose of this claimed invention, multi-primes are taken to represent all those sets of numbers that are evenly divisible by a limited group of integers where the number of the group is larger than two but less than some predetermined limits as indicated by the level of the multi-prime. For example, twenty-five is a three-multi-prime number because it is evenly divisible by only three numbers; one, five, and twenty-five. Six is a four-multi-prime number since it is evenly divisible by only four numbers; one, two, three, and six. Twelve is six-multi-prime; it is evenly divisible only by one, two, three, four, six, and twelve. Numbers evenly divisible by only two integers are ordinary primes. By setting a limit greater than two for the number of evenly divisible integers, the next-occurring multi-prime is not predictable so that these multi-primes capture the fundamental characteristic of prime numbers associated with the factoring process. Accordingly, multi-primes offer mathematical relationships or properties with the unpredictability of regular primes.

For the purpose of this claimed invention, super-primes (or a super-set of primes) are taken to represent sets of primes numbers for which supernumerary requirements have been imposed. For example, a set of super-primes could have the additional condition that the sum of the digits of a super-prime candidate must total another prime number. With this requirement, the group 13, 17, 19, 31, 37, 53, and 59 would not be super-prime while 2, 3, 5, 7, 11, 23, 29, 41, 43, and 47 would be super-prime. By placing additional restrictions on the characteristics of the set of prime numbers, these super-primes retain the fundamental characteristics of prime numbers offering mathematical relationships or properties with the unpredictability of regular primes.

For the purpose of this claimed invention, probable-primes are taken to represent sets of numbers that have passed certain tests designed to determine whether a number (particularly a very large number) is probably a prime. A number of sophisticated tests exist to make such determinations but other less elaborate tests could be applied. For example, the following very simple test could be used; a number greater than thirty-one could be considered to probably be a prime if it is not evenly divisible by one of the first eleven primes (2 through 31). This simple test correctly identifies the first two hundred and eight primes larger than thirty-one. This test does show thirteen hundred sixty-nine to probably be a prime number, which it is not. It correctly identifies the next larger twenty-one primes before again failing when it identifies the non-prime fifteen hundred seventeen as a prime. However, for an elaborate test with a reasonably limited likelihood of incorrectly identifying prime numbers, those probable-primes that pass the test exhibit the fundamental characteristics of prime numbers and offer mathematical relationships or properties with unpredictability comparable to those of regular primes.

For the purposes of this claimed invention, prime-like numbers include all those sets of numbers that share characteristics with prime numbers and for which the mathematical relationships or properties of such prime-like numbers exhibit the same non-predictable, essentially random characteristics as the relationships or properties between prime numbers. Prime-like numbers include the multi-primes, super-primes, and probable-primes described herein as well as all the combinations of multi-multi-primes, super-multi-primes, probable-multi-primes, multi-super-primes, super-super-primes, probable-super-primes, multi-probable-primes, super-probable-primes, probable-probable-primes, and all other combinations of restrictions and extensions to the set of prime numbers.

The claimed invention introduces processes and apparati for generating a new class of random numbers called idem-random numbers. The processes and methods of the claimed invention exploit the mathematical relationships or properties of sequences of prime and prime-like numbers to create sequences of idem-random numbers. Idem-random numbers may be successfully replicated at distinct locations and at different times and are, therefore, not truly random. However, the nature of the numerical relationships or properties of sequences of prime and prime-like numbers introduces unpredictability into the sequences of idem-random numbers that is comparable to that of purely random sequences. In addition, the potential supply of prime and prime-like numbers is unlimited allowing for the creation of an unlimited quantity of idem-random numbers. Thus, the idem-random number generation processes and methods of the claimed invention offer significant advantages over those that generate pseudo-random numbers.

The first step in the idem-random number generation process is the identification of the first prime or prime-like number to be used. This number becomes the seed prime number for the sequence of prime or prime-like numbers. The seed prime number should advantageously be a very large number that is determined to be a prime or prime-like number. For prime-like numbers, the characteristics required for a number to satisfy the prime-like conditions must be chosen. The initial number could be selected through essentially any choice process yielding a number meeting the specified requirements. Such choice processes could include the use of random number generators, pseudo-random number generators, other idem-random number generators, or any other arbitrary selection process.

The second step in the idem-random number generation process is the identification of the sub-process to be used to determine the next prime or prime-like number in the sequence of such numbers. This sub-process becomes the seed sequence process for the generation of the sequence of prime or prime-like numbers. The seed sequence process should advantageously be a process that selects a set of distinct prime or prime-like numbers. For example, a process that continually selects the same prime or prime-like number would be insufficient for this purpose because a sequence containing the same prime number repeatedly would be predictable and non-random. The process could use a specific, repeating enumeration or it could use a selection based on the value of an external deterministic process. An example of a process using specific, repeating enumeration would include the sub-process that continually chose the next larger prime or prime-like number for the sequence. Another example of that process would be the selection of the thirteenth next larger, followed by the sixth next smaller, followed by the eleventh next larger, and then the second next smaller prime or prime-like number with the selection sequence then repeating. An example of using an external deterministic process would be utilizing an external pseudo-random number generator or some other deterministic sub-process to select the next prime or prime-like number for the sequence. Ideally, the specified seed sequence process should not select any specific prime or prime-like number more than a single time.

The third step in the idem-random number generation process is the identification of the mathematical relationship or property to be applied to one or more elements of the prime or prime-like number sequence. This relationship or property—denoted as the seed relationship process—could be a function with one or more variables utilizing standard mathematical operations either alone or in conjunction with one another such that inserting numbers from the prime or prime-like number sequence into the variable positions in such function yields a specific resulting number. The standard mathematical operations include among others addition, subtraction, multiplication, division, modulus remainder, exponentiation, and logarithmic transformation. For example, the mathematical relationship or property could be determined simply as the difference resulting from the subtraction of the smaller prime or prime-like number from the larger. As another example, the larger prime could be raised to the power of two from which would be subtracted the product of the second and fifth smaller prime or prime-like numbers with that result taken through the modulus remainder of the immediately smaller prime or prime-like number. In yet another example, the thirty-first digit of the double logarithm of the given prime or prime-like number could be used. An unlimited number of combinations of mathematical operations and functions is available for the creation of the process identifying the mathematical relationship or property which is applied to the sequence of prime or prime-like numbers. The seed relationship would not be required to be constant over the creation of the full output sequence; various relationships or properties could be used or cycled through to generate the output sequence. Such cycling could be predetermined or could be regulated by the use of external deterministic sub-processes such as pseudo-random number generators, other idem-random number generators, or any other arbitrary selection process.

The final step in the idem-random number generation process is the iterative application of the seed sequence process for the generation of a sequence of prime or prime-like numbers and the subsequent application of the seed relationship process to the elements of that generated prime or prime-like number sequence. Once the seed prime number is selected, the seed sequence process is used to generate the next required prime or prime-like number(s); the seed relationship process is applied to numbers in the resulting sequence of prime or prime-like numbers to yield the idem-random number output. In other words, the seed sequence process is used to generate the next prime or prime-like number(s) in a sequence of prime or prime-like numbers and the mathematical relationships or properties of such numbers are evaluated by the seed relationship process to yield the next idem-random number output. The generation and evaluation processes continue until the desired number of idem-random numbers have been generated. Because the number of prime and prime-like numbers is unlimited, the number of idem-random numbers is also unlimited.

For some applications, a specific distribution of the idem-random numbers may be desired, requiring additional processing to yield the specified distribution. For other applications, no specific distribution of idem-random numbers may be necessary. In those cases where additional processing is necessary, an optional distribution-transformation process may be applied. The specific components and characteristics of the distribution-transformation process are integrally related to the seed relationship process. For example, using the simple difference between sequential prime or prime-like numbers for the seed relationship process creates initial idem-random numbers that are almost always even numbers since all prime numbers except the integer two are odd numbers. The difference between two odd numbers is an even number. A simple choice for the final distribution-transformation process in this example would be to divide the initial idem-random number by two to create the final idem-random number output. The resulting final idem-random distribution would be over the range of integers larger than zero, although not uniformly distributed over that range. A uniform (or nearly uniform) distribution over the integers greater than or equal to zero and less than ten could be created by taking the modulus of the idem-random values by ten. In this sense, idem-random numbers are equivalent to truly random numbers; the processes generating the idem-random or truly random numbers must be evaluated and appropriate transformations applied in order to generate idem-random or truly random numbers with specifically desired distributions.

An advantage of the present claimed invention is that an unlimited quantity of idem-random numbers may be generated from a very limited set of initial choices. Those choices include the selection of the seed prime number, the seed sequence process, and the seed relationship process. When a specified distribution is required, an optional distribution-transformation process choice may also be required. From the initial seed prime number, iterative application of the seed sequence and the seed relationship processes generate candidate idem-random numbers. Optional application of the distribution-transformation process creates final idem-random numbers with the specified distribution characteristics. The idem-random number generation process is fully deterministic—given identical choices for the seed prime number, the seed sequence process, the seed relationship process, and the optional distribution-transformation process, an identical sequence of idem-random numbers may be generated. However, each sequential idem-random result is based on the non-trivial determination of the next sequential prime or prime-like number. No efficient algorithm exists for predicting such prime or prime-like numbers. Thus, anticipation or prediction of the next sequential idem-random value is effectively impossible, a fundamental characteristic of truly random numbers. Thus, while the idem-random number generation process is fully deterministic, the idem-random number values so generated are effectively indistinguishable from truly random numbers.

### BRIEF DESCRIPTION OF THE DRAWINGS

FIG. 1 is a block diagram depicting the functional components of a prime-number-based random number generator denoted as an idem-random number generator, according to the invention claimed herein.

FIG. 2 is a block diagram depicting the functional components of a prime-like-number-based random number generator denoted as an idem-random number generator, according to the invention claimed herein.

FIG. 3 is a block diagram depicting the functional components of a prime-number-based idem-random number generator that creates idem-random numbers with specific distribution characteristics, according to the invention claimed herein.

FIG. 4 is a block diagram depicting the functional components of a prime-like-number-based idem-random number generator that creates idem-random numbers with specific distribution characteristics, according to the invention claimed herein.

FIG. 5 is a block diagram depicting a specific example of a prime-number-based idem-random number generator, according to the invention claimed herein.

### DESCRIPTION OF THE PREFERRED EMBODIMENT

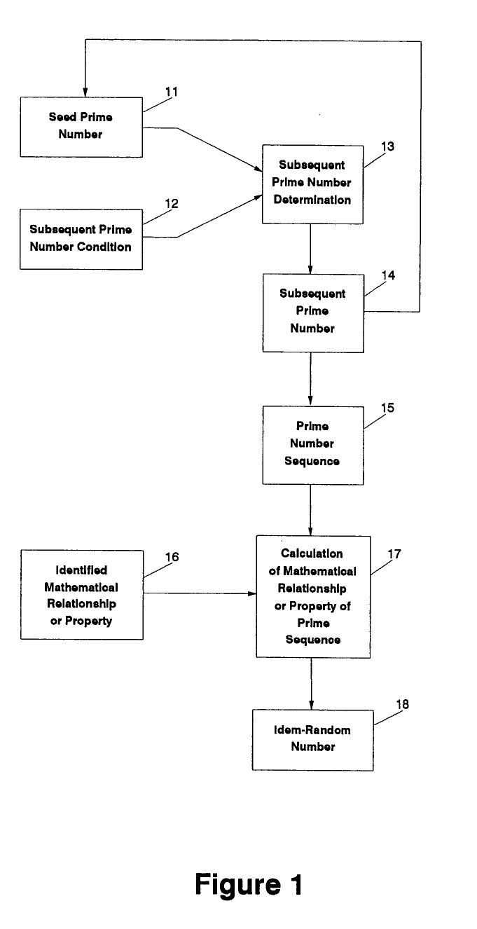

Referring to FIG. 1, a block diagram of the prime-number-based idem-random number generator method and apparatus of the claimed invention is shown which incorporates a seed prime number input 11, a subsequent prime number condition 12, application of the subsequent prime number condition 12 through a subsequent prime number determination process 13 to produce a subsequent prime number 14, iterative application of the subsequent prime number determination process 13 to each subsequent prime number 14 to generate a prime number sequence 15 comprising the seed prime number 11 and each subsequently determined prime number 14, determination of an identified mathematical relationship or property 16, and a calculation process 17 for determining the identified mathematical relationship or property 16 of the prime number sequence 15 to generate an idem-random number output 18.

The first step in the idem-random number generation process is the identification of the first prime number to be used as the seed prime number 11. This seed prime number should advantageously be a very large prime number selected through a choice process that could include the use of random number generators, pseudo-random number generators, other idem-random number generators, or other arbitrary selection process. In the second step, a condition 12 is chosen that identifies a subsequent prime number in a sequence of such numbers. This condition 12 is applied to the seed prime number 11 in a selection process 13 that determines the next prime number 14 in a sequence 15 of distinct prime numbers. The selection condition 12 could be a regularly repeating enumeration or it could be based on the value of an external deterministic process. An example of the former would be the condition that the next larger prime number be used for the sequence while the latter could be an external pseudo-random number generator used to establish the selection condition. The selection condition 12 should beneficially not lead to any specific prime number being selected more than a single time in the prime number sequence 15 by the selection process 13. Once the next prime number 14 in a sequence 15 of distinct prime numbers is determined by the selection process 13, that prime number 14 is utilized as the next seed prime number 11 for the following iteration of the prime number selection process 13. Iterative application of the selection process 13 to each resulting prime number 14 yields a prime number sequence 15.

In the third step, an identified mathematical relationship or property 16 is applied to the prime number sequence 15 in a calculation process 17 to yield the idem-random number output 18. This identified mathematical relationship or property 16 could be any of the standard mathematical operations either alone or in conjunction with one another such that the resulting calculation 17 of the relationship or property provided a quantitative comparison between a given prime number 14 and the immediately preceding or another prior preceding prime number 14 in the sequence 15. An unlimited number of combinations of mathematical operations and functions is available for selection as the identified mathematical relationship or property 16 to be calculated for the sequence of prime numbers 15. The idem-random number output 18 is the result of the calculated mathematical relationship or property 17 specified in the identification 16 as applied to the prime number sequence 15. Finally, the creation of many idem-random numbers 18 is achieved by the iterative generation of the sequence of prime numbers 15 and the subsequent calculation 17 of the mathematical relationship or property of that generated prime number sequence 15. Each prime number 14 in the sequence of prime numbers 15 becomes a seed prime number 11 for the determination of additional values in the sequence of prime numbers 15. The identified mathematical relationship or property 16 could vary over the calculation of the full output sequence; such relationship or property could be changed during the generation of the output sequence either by cycling through a predetermined set or by basing the selection on the value of an external deterministic process such as a pseudo-random number generator. Since the number of prime numbers available for inclusion in the sequence of prime numbers 15 is unlimited, the calculation 17 of the identified mathematical relationship or property 16 yields an unlimited number of idem-random number output values 18. The prime-number-based idem-random numbers generated by the process described for FIG. 1 will have a characteristic distribution determined by the natural prime number properties, the next prime number selection condition 12, and the identified mathematical relationship or property 16.

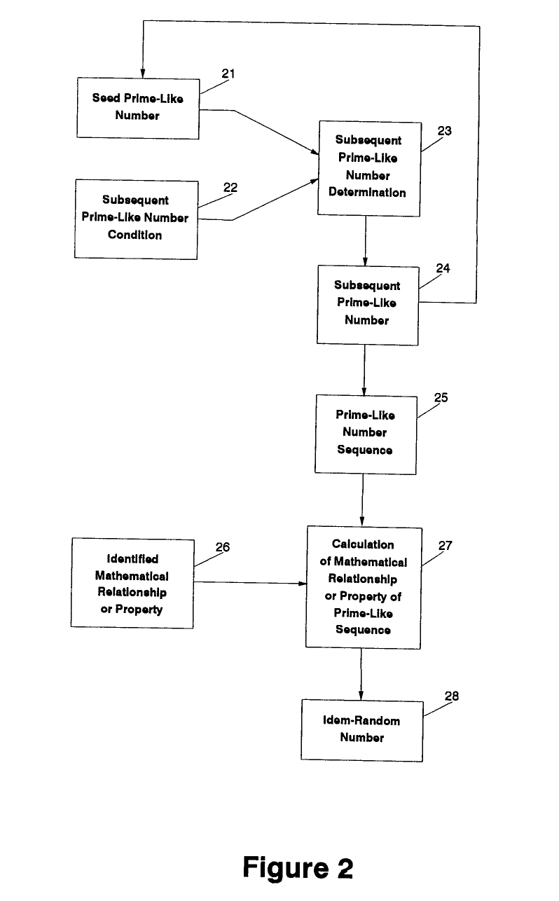

The idem-random number generator of the claimed invention can be based on the characteristics of prime-like numbers in addition to those of prime numbers as described for FIG. 1. Such prime-like numbers include all those sets of numbers that share characteristics with prime numbers and for which the mathematical relationships or properties of such prime-like numbers exhibit the same non-predictable, essentially random characteristics as the relationships or properties between prime numbers. Prime-like numbers include the multi-primes, super-primes, and probable-primes described herein as well as all the combinations of multi-multi-primes, super-multi-primes, probable-multi-primes, multi-super-primes, super-super-primes, probable-super-primes, multi-probable-primes, super-probable-primes, probable-probable-primes, and all other combinations of restrictions and extensions to the set of prime numbers. Referring to FIG. 2, a block diagram of the prime-like-number-based idem-random number generator system of the claimed invention is shown which incorporates a seed prime-like number input 21, a subsequent prime-like number condition 22, a subsequent prime-like number determination process 23, application of the prime-like number determination process 23 to generate a next prime-like number 24, a set or sequence 25 of such prime-like numbers 24, an identified mathematical relationship or property 26, and a calculation process 27 for determining the identified mathematical relationship or property of the prime-like number sequence 25 to generate an idem-random number output 28. Similar to the prime-number-based idem-random number generator described in FIG. 1, the first step in the prime-like idem-random number generation process is the identification of the first prime-like number to be used as the seed prime-like number 21. However, when using a process based on prime-like numbers, the characteristics required for a number to satisfy the particular prime-like conditions must be chosen and the seed prime-like number 21 must satisfy those chosen conditions. This seed prime-like number 21 should advantageously be a very large prime-like number selected through a choice process that could include the use of random number generators, pseudo-random number generators, other idem-random number generators, or other arbitrary selection process. In the second step, a condition 22 is chosen that identifies a subsequent prime-like number in the sequence of such numbers. This condition is combined with the seed prime-like number 21 in a selection process 23 that determines the next prime-like number 24 in a sequence 25 of distinct prime-like numbers. The selection condition 22 could be a regularly repeating enumeration or it could be based on the value of an external deterministic process. An example of the former would be the condition that the next larger prime-like number be used for the sequence while the latter could be an external pseudo-random number generator used to establish the selection condition. The selection condition 22 should beneficially not lead to any specific prime-like number being selected more than a single time in the prime-like number sequence 25 by the selection process 23. Once the next prime-like number 24 in a sequence 25 of distinct prime-like numbers is determined by the selection process 23, that prime-like number 24 becomes the next seed prime-like number 21 for the following iteration of the prime-like number selection process 23. In the third step, an identified mathematical relationship or property 26 is applied to the prime-like number sequence 25 in a calculation process 27 to yield the idem-random number output 28. This identified mathematical relationship or property 26 could be any of the standard mathematical operations either alone or in conjunction with one another such that the resulting calculation 27 of the relationship or property provided a quantitative comparison between a given prime-like number 24 and the immediately preceding or another prior preceding prime-like number 24 in the sequence 25. An unlimited number of combinations of mathematical operations and functions is available for selection as the identified mathematical relationship or property 26 to be applied to the sequence of prime-like numbers 25. The idem-random number output 28 is the result of the calculated mathematical relationship or property 27 specified in the identification 26 as applied to the prime-like number sequence 25. Finally, the creation of many idem-random numbers 28 is achieved by the iterative generation of the sequence of prime-like numbers 25 and the subsequent calculation 27 of the mathematical relationship or property 26 of that generated prime-like number sequence 25. Each prime-like number 24 in the sequence of prime-like numbers 25 becomes a seed prime-like number 21 for the determination of additional values in the sequence of prime-like numbers 25. The identified mathematical relationship or property 26 could vary over the calculation of the full output sequence; such relationship or property could be changed during the generation of the output sequence either by cycling through a predetermined set or by basing the selection on the value of an external deterministic process such as a pseudo-random number generator. Since the number of prime-like numbers available for inclusion in the sequence of prime-like numbers 25 is unlimited, the calculation 27 of the identified mathematical relationship or property 26 yields an unlimited number of idem-random number output values 28. The prime-like-number-based idem-random numbers generated by the process described for FIG. 2 will have a characteristic distribution determined by the natural prime-like number properties, the next prime-like number selection condition 22, and the identified mathematical relationship or property 26.

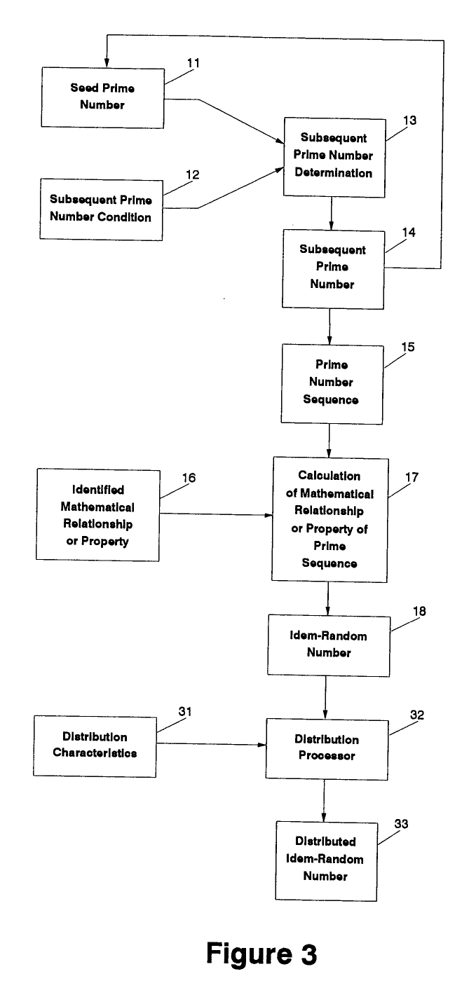

For some applications, a specific distribution of prime-based idem-random numbers may be desired, requiring additional processing to yield the specified distribution. FIG. 3 demonstrates a preferred embodiment of the prime-based idem-random number generation process of the claimed invention including such additional processing to yield specifically distributed idem-random numbers 33 matching the specified distribution characteristics 31.

The specific components and characteristics of the distribution transformation process incorporated into the distribution processor 32 are integrally related to the characteristics of the initial, non-transformed idem-random numbers 18 generated by the process described herein and best shown in FIG. 1. In this way idem-random numbers are fully equivalent to truly random numbers; the processes generating the idem-random or truly random numbers must be evaluated and appropriate transformations applied in order to generate idem-random or truly random numbers with specifically desired distributions.

Referring to FIG. 3, a block diagram of the initial prime-number-based idem-random number generator system of the claimed invention comparable to that in FIG. 1 is shown that incorporates a seed prime number input 11, a subsequent prime number condition 12, a subsequent prime number determination process 13 yielding a subsequent prime number 14, a generated prime number sequence 15 of such prime numbers 14, an identified mathematical relationship or property 16, a calculation process 17 for determining the identified mathematical relationship or property of the prime number sequence 15 to generate an idem-random number output 18. The iterative application of the initial steps in FIG. 3 required to generate a sequence of idem-random numbers 18 is identical to those same steps shown in FIG. 1. The further generation of idem-random numbers with specifically desired distributions 33 is accomplished by specifying the desired distribution characteristics 31 and applying appropriate transformations or other operations through the distribution processor 32 to the non-transformed idem-random number sequence 18. The number of prime numbers available for inclusion in the sequence of prime numbers 15 is unlimited. The calculation 17 of the identified mathematical relationship or property 16 of those prime numbers 15 yields an unlimited number of initial idem-random number output values 18 which are then transformed through the distribution processor 32 into an unlimited number of appropriately distributed idem-random numbers 33.

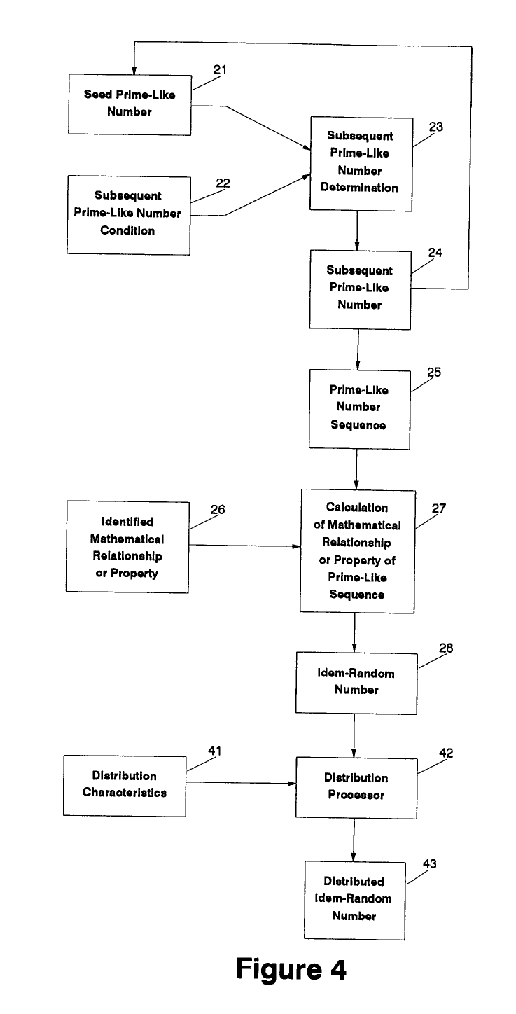

Similarly, for some applications, a specific distribution of prime-like-based idem-random numbers may be desired, requiring additional processing of the process shown in FIG. 2 to yield the specified distribution. FIG. 4 demonstrates a preferred embodiment of the prime-like-based idem-random number generation process of the claimed invention including such additional processing to yield specifically distributed idem-random numbers 43 matching the specified distribution characteristics 41. The specific components and characteristics of the distribution transformation process incorporated into the distribution processor 42 are integrally related to the characteristics of the initial, non-transformed idem-random numbers 28 generated by the process described herein. In this way prime-like-based idem-random numbers are fully equivalent to truly random numbers; the processes generating the idem-random or truly random numbers must be evaluated and appropriate transformations applied in order to generate idem-random or truly random numbers with specifically desired distributions.

Referring to FIG. 4, a block diagram of the initial prime-like-based idem-random number generator system of the claimed invention comparable to that in FIG. 2 is shown that incorporates a seed prime-like number input 21, a subsequent prime-like number condition 22, a subsequent prime-like number determination process 23, a generated prime-like number sequence 25 comprising a set of subsequent prime-like numbers 24, an identified mathematical relationship or property 26, a calculation process 27 for determining the identified mathematical relationship or property of the prime-like number sequence 25 to generate a prime-like-based idem-random number output 28. The iterative application of the initial steps in FIG. 4 required to generate a sequence of idem-random numbers 28 is identical to those same steps shown in FIG. 2. The further generation of prime-like-based idem-random numbers with specifically desired distributions 43 is accomplished by specifying the desired distribution characteristics 41 and applying appropriate transformations or other operations through the distribution processor 42 to the non-transformed idem-random number sequence 28. The number of prime-like numbers available for inclusion in the sequence of prime-like numbers 25 is unlimited. The calculation 27 of the identified mathematical relationship or property 26 of those prime-like numbers 25 yields an unlimited number of initial idem-random number output values 28 which are then transformed through the distribution processor 42 into an unlimited number of appropriately distributed prime-like-based idem-random numbers 43.

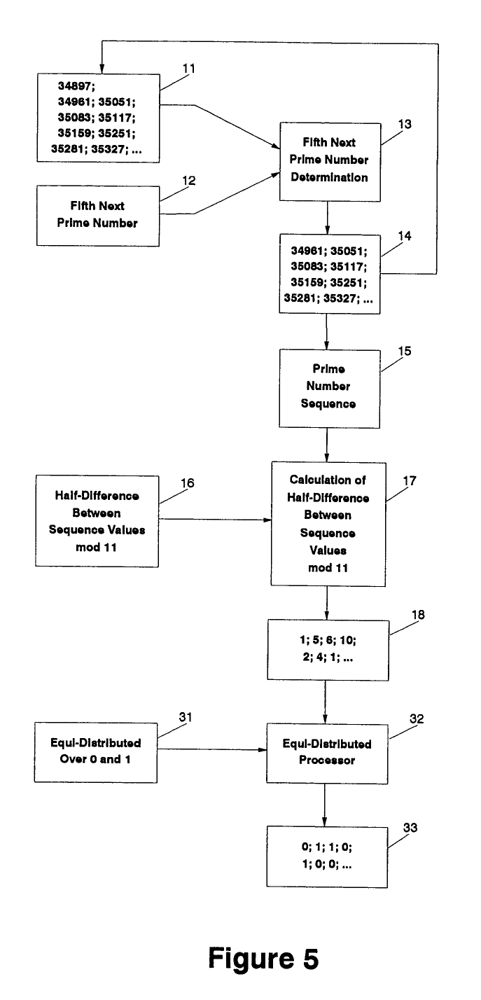

A numerical example of one embodiment of the idem-random number generator of the claimed invention is shown in FIG. 5. In that example, the seed prime number 11 is 34897, the subsequent prime number condition 12 is the fifth next prime, the mathematical relationship 16 is one-half of the difference between successive prime sequence values with that difference then taken modulus eleven, and the result 18 is equally distributed through a distribution processor 32 over the range of zero and one. From 34897, the fifth next prime is 34961 which becomes the first value 14 of the prime number sequence 15 and is used as the next seed prime. From 34961, the fifth next prime is 35051, which becomes the next value 14 of the prime number sequence 15 and is used as yet the next seed prime. Subsequent primes in the sequence 15 are 35083, 35117, 35159, 35251, 35281, 35327, etc. One-half of the difference between the successive values of the sequence yields the results 45, 16, 17, 21, 46, 15, 23, etc. These values modulus eleven are the idem-random numbers 1, 5, 6, 10, 2, 4, 1, etc. The desired distribution characteristic 31 is equally distributed binary values, that is, a distribution that is equally probable for the results of zero and one. A modulus two operation would distribute the idem-random numbers above over the desired range, but would generate relatively more zeros than ones. Accordingly, the distribution processor 32 takes the modulus two operation of each idem-random value and inverts every other one—that is, converts a zero to a one or a one to a zero; this processor generates distributed idem-random numbers that are equally distributed between the values of zero and one. The distributed idem-random number results 33 are 0, 1, 1, 0, 1, 0, 0, etc.

Although the present claimed invention has been described in terms of the presently preferred embodiment, it is to be understood that such disclosure is purely illustrative and is not to be interpreted as limiting. Consequently, without departing from the spirit and scope of the claimed invention, various alterations, modifications, and/or alternative applications of the claimed invention will, no doubt, be suggested to those skilled in the art after having read the preceding disclosure. Accordingly, it is intended that the following claims be interpreted as encompassing all alterations, modifications, or alternative applications as fall within the true spirit and scope of the claimed invention.

1. A method of generating an idem-random number, said method comprising the steps of:
a. Establishing an initial prime number;
b. Establishing a subsequent prime number identification condition;
c. Determining a first subsequent prime number satisfying the subsequent prime number identification condition applied to the initial prime number;
d. Identifying a mathematical relationship to be applied to said initial prime number and said subsequent prime number;
e. Applying said mathematical relationship to said initial prime number and said subsequent prime number to generate an idem-random number.

2. A method of generating a plurality of idem-random numbers, said method comprising the steps of:
a. Establishing an initial prime number;
b. Establishing a subsequent prime number identification condition;
c. Determining a first subsequent prime number satisfying the subsequent prime number identification condition applied to the initial prime number;
d. Determining at least one further subsequent prime number satisfying the subsequent prime number identification condition applied to a previously determined subsequent prime number;
e. Identifying a mathematical relationship to be applied to a plurality of numbers selected from a set of numbers including said initial prime number and said subsequent prime numbers;
f. Applying said mathematical relationship to a first subset of numbers selected from said set of numbers to generate a first idem-random number;
g. Applying said mathematical relationship to a second subset of numbers selected from said set of numbers to generate a subsequent idem-random number.

3. A method of generating a plurality of idem-random numbers according to claim 2, wherein said steps d. through g. are repeated to generate a desired number of idem-random numbers.

4. A method according to claim 2, further comprising the steps of:
h. Establishing desired distribution characteristics;
i. Determining a distribution operation to be applied to said idem-random numbers to create said desired distribution; and
j. Applying said distribution operation to said idem-random numbers to generate specifically distributed idem-random numbers.

5. A method according to claim 3, further comprising the steps of:
h. Establishing desired distribution characteristics;
i. Determining a distribution operation to be applied to said idem-random numbers to create said desired distribution; and
j. Applying said distribution operation to said idem-random numbers to generate specifically distributed idem-random numbers.

6. A method of generating an idem-random number, said method comprising the steps of:
a. Specifying particular prime-like characteristics to be satisfied;
b. Establishing an initial prime-like number which satisfies said prime-like characteristics;
c. Establishing a subsequent prime-like number identification condition;
d. Determining a first subsequent prime-like number satisfying the subsequent prime-like number identification condition applied to the initial prime-like number;
e. Identifying a mathematical relationship to be applied to said initial prime-like number and said subsequent prime-like number;
f. Applying said mathematical relationship to said initial prime-like number and said subsequent prime-like number to generate an idem-random number.

7. A method of generating a plurality of idem-random numbers, said method comprising the steps of:
a. Specifying particular prime-like characteristics to be satisfied;
b. Establishing an initial prime-like number which satisfies said prime-like characteristics;
c. Establishing a subsequent prime-like number identification condition;
d. Determining a first subsequent prime-like number satisfying the subsequent prime-like number identification condition applied to the initial prime-like number;
e. Determining at least one further subsequent prime-like number satisfying the subsequent prime-like number identification condition applied to a previously determined subsequent prime-like number;
f. Identifying a mathematical relationship to be applied to a plurality of prime-like numbers selected from a set of numbers including said initial prime-like number and said subsequent prime-like numbers;
g. Applying said mathematical relationship to a first subset of numbers selected from said set of numbers to generate a first idem-random number;
h. Applying said mathematical relationship to a second subset of numbers selected from said set of numbers to generate a subsequent idem-random number.

8. A method of generating a plurality of idem-random numbers according to claim 7, wherein said steps d. through g. are repeated to generate a desired number of idem-random numbers.

9. A method according to claim 7, further comprising the steps of:
h. Establishing desired distribution characteristics;
i. Determining a distribution operation to be applied to said idem-random numbers to create said desired distribution; and
k. Applying said distribution operation to said idem-random numbers to generate specifically distributed idem-random numbers.

10. A method according to claim 8, further comprising the steps of:
h. Establishing desired distribution characteristics;
i. Determining a distribution operation to be applied to said idem-random numbers to create said desired distribution; and
j. Applying said distribution operation to said idem-random numbers to generate specifically distributed idem-random numbers.

11. An apparatus for generating an idem-random number, said apparatus comprising:
a. Initial prime number establishment means for establishing an initial prime number;
b. Subsequent prime number identification condition means for establishing a subsequent prime number identification condition;
c. Determination means for determining a first subsequent prime number satisfying the subsequent prime number identification condition applied to the initial prime number;
d. Mathematical relationship identification means for identifying a mathematical relationship to be applied to said initial prime number and said first subsequent prime number;
e. Calculation means for applying said mathematical relationship to said initial prime number and said first subsequent prime number to generate an idem-random number.

12. An apparatus for generating a plurality of idem-random numbers, said apparatus comprising:
a. Initial prime number establishment means for establishing an initial prime number;
b. Subsequent prime number identification condition means for establishing a subsequent prime number identification condition;
c. First determination means for determining a first subsequent prime number satisfying the subsequent prime number identification condition applied to the initial prime number;
d. Second determination means for determining at least one further subsequent prime number satisfying the subsequent prime number identification condition applied to a previously determined subsequent prime number;
e. Mathematical relationship identification means for identifying a mathematical relationship to be applied to a plurality of numbers selected from a set of numbers including said initial prime number and said subsequent prime numbers;
f. First calculation means for applying said mathematical relationship to a first subset of numbers selected from said set of numbers to generate a first idem-random number;
g. Second calculation means for applying said mathematical relationship to a second subset of numbers selected from said set of numbers to generate a subsequent idem-random number.
